(19) United States
(12) Patent Application Publication
(10) Pub. No.: US 2004/0182151 A1
(43) Pub. Date: Sep. 23, 2004

(54) Fill level transducer

(76) Inventor: Benjamin Meure, Glen Iris (AU)

Correspondence Address: RONALD E. GREIGG, GREIGG & GREIGG P.L.L.C., Suite One, 1423 Powhatan Street, Alexandria, VA, 22314, US

(21) Appl. No.: 10/765,173

(22) Filed: Jan. 28, 2004

(30) Foreign Application Priority Data
Feb. 28, 2003 (DE) 2 03 03 296.9

(51) Int. Cl. G01F 23/38; G01F 23/36

(52) U.S. Cl. 73/313; 73/317; 73/DIG. 5

(57) ABSTRACT

Known fill level transducers are disposed in the open in a tank and thus exposed to the sometimes aggressive liquid in the tank. It is a disadvantage that from the liquid, unwanted deposits often occur on a potentiometer of the fill level transducer. The fill level transducer of the invention protects the potentiometer against the liquid contained in the tank in that the potentiometer is sealed off tightly from the tank and the liquid located in it, and that the fill level transducer has a float arm, which is in contactless operative connection with a wiper arm of the potentiometer.

### BACKGROUND OF THE INVENTION

1. Field of the Invention

The invention is directed to an improved fill level transducer for ascertaining the level of a liquid in a tank.

2. Description of the Prior Art

A fill level transducer known from German Patent Disclosure DE 199 56 216 A1 has a rotatable float arm, which is mechanically connected to a rotatable wiper arm of a potentiometer. The rotary angle of the float arm is dependent on the fill level of the fuel in a fuel tank. The wiper arm cooperates via a wiper contact with a wiper path of the potentiometer to generate a partial voltage as a function of a rotary angle of the float arm. In this fill level transducer, unwanted deposits often occur on the potentiometer, since the potentiometer is disposed in the fuel tank unprotected from the liquid. The deposits occur for instance from a chemical reaction of the liquid with the wiper path and/or the wiper contact, forming silver sulfide, for instance, which is deposited for instance on the wiper contact and the wiper path and leads to increased electrical resistance and hence to an incorrect measured value. These deposits occur especially markedly in the presence of chemically aggressive fuels.

### OBJECT AND SUMMARY OF THE INVENTION

The fill level transducer of the invention has the advantage over the prior art that in a simple way, an improvement is achieved by providing that no deposits form on the potentiometer, since the potentiometer is tightly sealed off from the tank and the liquid contained in it, and since the fill level transducer has a float arm which is in contactless operative connection with the wiper arm.

It is especially advantageous if the operative connection between the float arm and the wiper arm is formed by at least one magnetic field, because this makes a contactless operative connection possible. Because of the contactless operative connection, dynamic sealing that seals off the fill level transducer from the tank is not needed.

It is also advantageous to generate the magnetic field by at least one magnet, which is disposed on the float arm and/or on the wiper arm, since in this way a motion can be transmitted from the float arm to the wiper arm.

It is also advantageous if the at least one magnet is a permanent magnet.

It is furthermore advantageous to embody the permanent magnet as a bar magnet, since in this way the transmission of the rotary motion is especially good.

It is advantageous if the wiper arm is rotatably supported about a first pivot point and the float arm is rotatably supported about a second pivot point, and the first pivot point and the second pivot point are located one on top of the other.

It is advantageous if the first pivot point and the second pivot point are offset from one another such that the rotary angle of the wiper arm is always greater than the rotary angle of the float arm.

It is also advantageous if a first magnet is disposed in the first pivot point of the wiper arm, and a second magnet disposed in the second pivot point of the float arm.

It is also advantageous if the first magnet is disposed outside the first pivot point of the wiper arm, and the second magnet disposed outside the second pivot point of the float arm, since in this way a higher torque can be transmitted.

It is highly advantageous if the position sensor is provided in a housing, which is sealed off by a seal from the tank and the liquid located in the tank, since because of this encapsulation, no liquid penetrates the housing, and hence deposits no longer occur on the printed circuit board of the potentiometer.

### BRIEF DESCRIPTION OF THE DRAWING

The invention will be better understood and further objects and advantages thereof will become more apparent from the ensuing detailed description of a preferred embodiment taken in conjunction with single the drawing figure which schematically shows one exemplary embodiment of the invention.

### DESCRIPTION OF THE PREFERRED EMBODIMENT

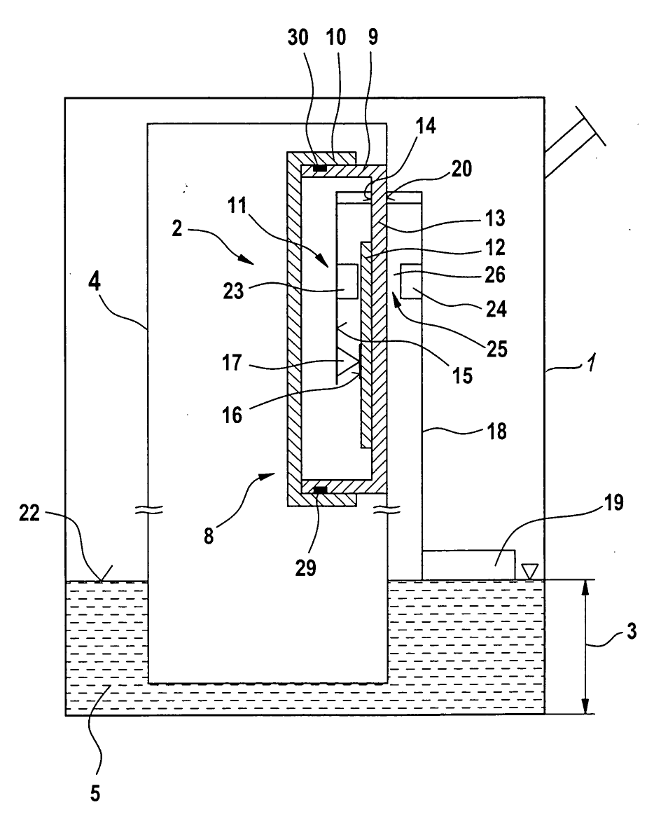

FIG. 1 shows a fill level transducer for measuring a fill level of liquid in a tank.

The fill level transducer of the invention serves to measure the fill level in a liquid-filled tank, in which the liquid is for instance chemically aggressive.

In a tank 1, a fill level sensor 2 is provided. The fill level sensor 2 serves to measure a fill level 3 of a liquid 5 in the tank 1.

The fill level sensor 2 is disposed for instance on a pumping module 4 provided in the tank 1, which aspirates liquid 5 located in the tank 1 and pumps it out of the tank 1. The fill level sensor 2 can, however, also be disposed on the wall of the tank 1, specifically inside and outside the tank 1.

The tank 1 is for instance a fuel tank; the liquid 5 is for instance fuel; and the pumping module 4 is for instance a fuel pumping module, which pumps fuel out of the fuel tank to an internal combustion engine.

A fuel pumping module with which the invention may be used is known for instance from German Patent Disclosure DE 199 15 255 A1, which is hereby expressly incorporated by reference.

However, the device according to the invention is not limited to that use and can expressly also be used in other fields.

The fill level sensor 2 has a housing 8, which for instance comprises a cup-shaped housing part 9 and a cap 10. The cap 10 closes off the housing 8 tightly from the tank 1 and the liquid 5 contained in it. The cap 10 is for instance flanged, clipped, glued or welded to the cup-shaped housing part 9.

A position sensor, for instance a potentiometer 11, is disposed in the housing 8. The potentiometer 11 comprises a printed circuit board 12 and a wiper arm 15, which is supported linearly movably or for instance rotatably at a first pivot point 14. The printed circuit board 12 and the first pivot point of the wiper arm 15 are disposed for instance on a bottom 13 of the cup-shaped housing part 9. At least one electrically conductive wiper path 16 is provided on the printed circuit board 12. Via at least one wiper contact 17, the wiper arm 15 touches the at least one wiper path 16. The wiper path 16 is either elongated or is for instance curved and embodied concentrically with the first pivot point 14.

On the side of the bottom 13 opposite the printed circuit board 12, a float arm 18 is provided, supported for instance rotatably in a second pivot point 20. A float 19 is provided on the end of the float arm 18 remote from the housing 8 of the fill level sensor 2. The float 19 is embodied such that its specific density, formed from the quotient of weight and volume, is less than the specific density of the liquid 5. The float 19 is therefore located wherever the surface 22 of the liquid 5 is located. If the fill level 3 in the tank 1 changes, the float 19 follows the liquid surface 22. The float arm 18 coupled to the float 19 moves with the float 19, executing a motion in the process, for instance a rotary motion. The location of the float arm 18, for instance in the form of a rotary angle between 0° and 360°, is a measure for the fill level 3.

The wiper arm 15 for instance has a first magnet 23, and the float arm 18 for instance has a second magnet 24. The first magnet 23 is for instance disposed outside the first pivot point 14 and the second magnet 24 is for instance disposed outside the second pivot point 20. However, it is also possible for the first magnet 23 to be provided in the first pivot point 14 and the second magnet 24 to be provided in the second pivot point 20. The first magnet 23 and the second magnet 24 are secured to the wiper arm 15 and to the float arm 18, respectively, for instance by means of an adhesive bond, screws, or clips. However, it is also possible for the wiper arm 15 for instance to be embodied as a first magnet 23. The first magnet 23 and the second magnet 24 are for instance permanent magnets. The first magnet 23 and the second magnet 24 are for instance elongated bar magnets or point-shaped magnets.

The first magnet 23 and second magnet 24 are polarized in such a way that they attract one another. Because of the magnetic fields generated by the first magnet 23 and second magnet 24, the wiper arm 15 and float arm 18 are in operative connection with one another in such a way that a motion of the float arm 18 is transmitted in contactless fashion to the wiper arm 15.

Between the first magnet 23 and the second magnet 24, an interstice 25 is provided, in which at least the bottom 13 is disposed. The bottom 13 comprises a nonmagnetic material, such as plastic. Additionally, however, the interstice 25 can for instance include an air gap 26 and/or the printed circuit board 12. The interstice 25 is designed such that the operative connection between the first magnet 23 and the second magnet 24 is sufficient to cause arm 15 to follow arm 13.

The first magnet 23 and the second magnet 24 each have a magnetic field which penetrates the interstice 25 and, because of the mutual attraction, transmits the motion of the float arm 18 to the wiper arm 15 in such a way that at all times the wiper arm 15 and the float arm 18 assume the same position, or in other words have the same rotary angle of between 0° and 360°. In this way, the float arm 18 and the wiper arm 15 overlay one another. Any angular difference between the float arm 18 and the wiper arm 15 would lead to a measurement error, which naturally is to be avoided.

The larger the gap 25, the stronger the magnetic field of the first magnet 23 and the second magnet 24 must be in order to transmit the motion of the float arm 18 to the wiper arm 15, and also the larger the first magnet 23 and the second magnet 24 must be. In designing the first magnet 23 and the second magnet 24, the resistance for displacing the wiper contact 17 along the wiper path 16 must also be taken into account.

Any change in the fill level 3 causes a displacement of the wiper contact 17 on the wiper path 16, by way of the motion of the float arm 18 and the wiper arm 15. A total voltage is applied to the wiper path 16. Via the wiper contact 17 and the wiper arm 15, a partial voltage is picked up from the total voltage and represents a measure of the fill level 3 in the tank 1.

The first pivot point 14 and the second pivot point 20 are disposed concentrically to one another, for instance, so that the rotary motion of the float arm 18 is transmitted at a ratio of 1:1 to the wiper arm 15.

However, it is also possible for the first pivot point 14 and the second pivot point 20 to be shifted relative to one another in the direction of the bottom 13 in such a way that the rotary motion of the float arm 18 is transmitted to the wiper arm 15, thereby increasing the rotary angle.

In another embodiment, only the first magnet 23, or only the second magnet 24, is provided. In that case, either the wiper arm 15 or the float arm 18 is embodied at least in part of a magnetic material, such as iron, nickel, or cobalt, or a ferromagnetic alloy, and is not provided with any magnet. The magnetic field of the first magnet 23 or the second magnet 24 brings about magnetization in the magnetic material in a known manner.

As a result of the contactless transmission of the motion of the float arm 18 to the wiper arm 15, no mechanical coupling of the float arm 18 to the wiper arm 15, and hence no opening in the bottom 13 for a coupling with the float arm 18, is necessary. This simplifies sealing off the housing 8 considerably, so that for a disposition in the tank 1, only a so-called static seal 29, such as a sealing ring, is needed. The static seal 29 is provided for instance in a sealing groove, which is disposed extending around the outer circumference of the cup-shaped housing part. However, the housing 8 can also be effectively sealed off by adhesive bonding or welding. Because of the encapsulation of the housing 8, in contrast to the prior art, no contact occurs between the liquid 5 and the potentiometer 11, so that no deposits from the liquid 5 can occur for instance on the wiper contact 17, the wiper path 16, or the printed circuit board 12.

The foregoing relates to preferred exemplary embodiments of the invention, it being understood that other variants and embodiments thereof are possible within the spirit and scope of the invention, the latter being defined by the appended claims.

I claim:

1. A fill level transducer for ascertaining a liquid level in a tank filled with a liquid, comprising a float arm carrying a float, a position sensor having a wiper arm, and means providing contactless operative connection between the float arm and the wiper arm.

2. The fill level transducer in accordance with claim 1, wherein the operative connection between the float arm (18) and the wiper arm (15) comprises at least one magnetic field.

3. The fill level transducer in accordance with claim 2, wherein the at least one magnetic field is generated by at least one magnet (23, 24), which is disposed on the float arm (18) and/or on the wiper arm (15).

4. The fill level transducer in accordance with claim 3, wherein the at least one magnet (23, 24) is a permanent magnet.

5. The fill level transducer in accordance with claim 4, wherein that the permanent magnet is embodied as a bar magnet.

6. The fill level transducer in accordance with claim 1, further comprising means rotationally supporting the wiper arm (15) about a first pivot point (14) and means rotationally supporting float arm (18) about a second pivot point (20), and wherein the first pivot point (14) and the second pivot point (20) are disposed concentrically.

7. The fill level transducer in accordance with claim 1, further comprising means rotationally supporting the wiper arm (15) about a first pivot point (14) and means rotationally supporting float arm (18) about a second pivot point (20), and wherein the through (20), and wherein the first pivot point (14) and the second pivot point (20) are offset from one another such that the rotary angle of the wiper arm (15) is always greater than the rotary angle of the float arm (18).

8. The fill level transducer in accordance with claim 6, wherein the first magnet (23) is disposed in the first pivot point (14) of the wiper arm (15), and the second magnet (24) disposed in the second pivot point (20) of the float arm (18).

9. The fill level transducer in accordance with claim 6, wherein the first magnet (23) is disposed outside the first pivot point (14) of the wiper arm (15), and the second magnet (24) disposed outside the second pivot point (20) of the float arm (18).

10. The fill level transducer in accordance with claim 7, wherein the first magnet (23) is disposed outside the first pivot point (14) of the wiper arm (15), and the second magnet (24) disposed outside the second pivot point (20) of the float arm (18).

11. The fill level transducer in accordance with claim 1, wherein the position sensor (11) is provided in a housing (8), and the housing (8) is wherein sealed off by a seal (29) from the tank (1) and any liquid (5) located in the tank (1).

12. The fill level transducer in accordance with claim 2, wherein the position sensor (11) is provided in a housing (8), and the housing (8) is wherein sealed off by a seal (29) from the tank (1) and any liquid (5) located in the tank (1).

13. The fill level transducer in accordance with claim 6, wherein the position sensor (11) is provided in a housing (8), and the housing (8) is wherein sealed off by a seal (29) from the tank (1) and any liquid (5) located in the tank (1).

14. The fill level transducer in accordance with claim 7, wherein the position sensor (11) is provided in a housing (8), and the housing (8) is wherein sealed off by a seal (29) from the tank (1) and any liquid (5) located in the tank (1).

15. The fill level transducer in accordance with claim 8, wherein the position sensor (11) is provided in a housing (8), and the housing (8) is wherein sealed off by a seal (29) from the tank (1) and any liquid (5) located in the tank (1).

16. The fill level transducer in accordance with claim 9, wherein the position sensor (11) is provided in a housing (8), and the housing (8) is wherein sealed off by a seal (29) from the tank (1) and any liquid (5) located in the tank (1).
